(19) United States
(12) Patent Application Publication
(10) Pub. No.: US 2025/0354346 A1
(43) Pub. Date: Nov. 20, 2025

(54) SPLICING LEVELER

(71) Applicant: Dongguan Wenzhi Network Technology Co., Ltd., Guangdong (CN)

(72) Inventor: Bin CHEN, Guangdong (CN)

(73) Assignee: Dongguan Wenzhi Network Technology Co., Ltd., Guangdong (CN)

(21) Appl. No.: 19/283,570

(22) Filed: Jul. 29, 2025

(30) Foreign Application Priority Data
Dec. 20, 2024 (CN) 2024231677366

(51) Int. Cl. E02F 3/02; B25G 1/04; F16B 7/04

(52) U.S. Cl. CPC E02F 3/02; B25G 1/04; F16B 7/042

(57) ABSTRACT

A splicing leveler includes a splicing hand grip rod. The splicing hand grip rod is connected with a leveling frame, a handheld ring is detachably installed on the splicing hand grip rod, the splicing hand grip rod includes at least two splicing pipes and a plurality of hand grip rod extension fixators, two adjacent splicing pipes are detachably connected through the hand grip rod extension fixators. The splicing leveler is of a novel structure, and effectively reduces the space occupied by the leveler during storage and transportation, facilitating convenient storage and transportation of the leveler.

### CROSS-REFERENCE TO RELATED APPLICATIONS

The present disclosure claims priority to Chinese Patent Application No. 202423167736.6, filed on Dec. 20, 2024, the entire contents of which are incorporated herein by reference.

### TECHNICAL FIELD

The present disclosure relates to a splicing leveler.

### BACKGROUND

Levelers play a vital role in many scenarios such as agricultural production and earthwork construction. They are mainly used to flatten materials such as loose soil piles and fertilizer piles to ensure smooth progress of subsequent tasks such as sowing and land leveling. At present, most commonly-used levelers are designed with a long handle hand grip rod.

### SUMMARY

The present disclosure relates to a splicing leveler. The splicing leveler includes a splicing hand grip rod. The splicing hand grip rod is connected with a leveling frame, a handheld ring is detachably installed on the splicing hand grip rod, the splicing hand grip rod includes at least two splicing pipes and a plurality of hand grip rod extension fixators, and two adjacent splicing pipes are detachably connected through the hand grip rod extension fixators.

### BRIEF DESCRIPTION OF THE DRAWINGS

FIG. 1 is a schematic structural diagram of an overall structure of a splicing leveler in an embodiment;

FIG. 2 is a local area view of the structure shown in FIG. 1;

FIG. 3 is a schematic structural diagram of a hand grip rod extension fixator in an embodiment;

FIG. 4 is an exploded view of a hand grip rod extension fixator in an embodiment;

FIG. 5 is a schematic structural diagram of a partial area of a splicing hand grip rod in an embodiment;

FIG. 6 is a schematic structural diagram I of a splicing leveler in a storage state in an embodiment;

FIG. 7 is a schematic structural diagram II of a splicing leveler in a storage state in an embodiment;

FIG. 8 is a schematic structural diagram of a connector in an embodiment;

FIG. 9 is a schematic structural diagram of an overall structure of a splicing leveler in another embodiment; and

FIG. 10 is an enlarged view of detail A in FIG. 9.

### DETAILED DESCRIPTION OF THE EMBODIMENTS

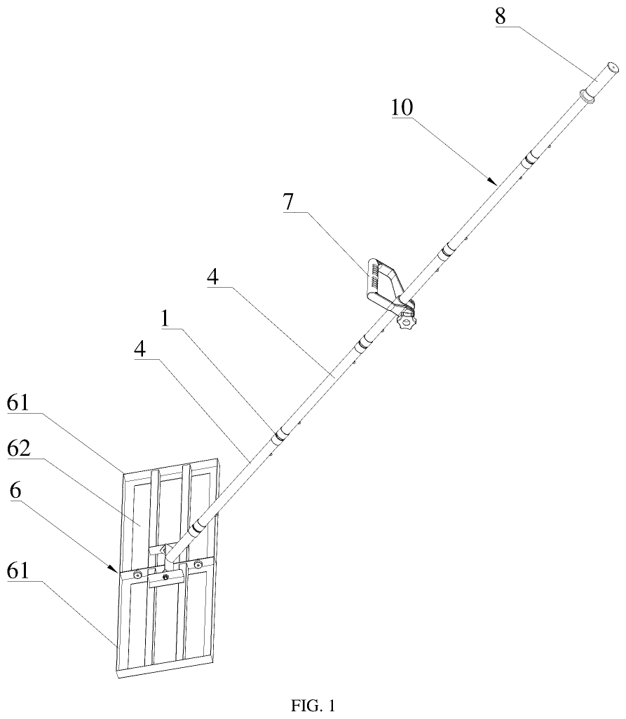

With reference to FIG. 1 to FIG. 10, the splicing leveler includes a splicing hand grip rod 10. The splicing hand grip rod 10 is connected with a leveling frame 6, a handheld ring 7 is detachably installed on the splicing hand grip rod 10, the splicing hand grip rod 10 includes at least two splicing pipes 4 and a plurality of hand grip rod extension fixators 1, and two adjacent splicing pipes 4 are detachably connected through the hand grip rod extension fixators 1.

The splicing leveler is of a novel structure. The splicing hand grip rod 10 is formed by splicing the plurality of splicing pipes 4 and the hand grip rod extension fixators 1, and the hand-held ring 7 is detachably mounted on the splicing hand grip rod 10. This effectively reduces the space occupied by the leveler during storage and transportation, facilitating convenient storage and transportation of the leveler. Meanwhile, the risk of damage to the leveler during transportation can also be reduced, thereby prolonging the service life of the leveler.

In one or more embodiments, the hand grip rod extension fixator 1 includes a cylindrical main body 11. Elastic rubber plug 2 are arranged at two ends of the main body 11, The elastic rubber plug 2 is provided with an exposed section 21 exposed out of the main body 11, and the exposed section 21 has a greater diameter than the main body 11. Two locking assemblies 3 are further arranged on the main body 11 and are respectively disposed close to the two ends of the main body 11. Each locking assembly 3 includes at least one elastic clamping head 31. An end portion of the main body 11 is inserted into the splicing pipe 4, a clamping hole 41 is formed in the splicing pipe 4 and matched with the clastic clamping head 31, and the exposed section 21 abuts against an inner wall of the splicing pipe 4.

The hand grip rod extension fixator 1 is of a simple structure, and can effectively connect two splicing pipes 4. The elastic rubber plug 2 on the hand grip rod extension fixator 1 can ensure a tight fit between the hand grip rod extension fixator 1 and the splicing pipes 4, providing good structural stability, and effectively reducing wobbling in the splicing hand grip rod 10. The splicing hand grip rod 10 is convenient to disassemble and assemble. Even after repeated use, the splicing hand grip rod 10 can still have good structural stability, providing a good user experience.

In one or more embodiments, the elastic rubber plug 2 further includes an insertion section 22 connected with the exposed section 21. The insertion section 22 is inserted into the main body 11 to be in interference fit with the main body 11. The exposed section 21 is provided with a plurality of notches 211, and the notches 211 extend from one end, away from the insertion section 22, of the exposed section 21 to the insertion section 22.

The notches 211 in the exposed section 21 allow the exposed section 21 to be deformed to a certain extent, thereby enabling the exposed section 21 to better abut against the inner wall of the splicing pipe 4. The main body 11 is simply connected with the elastic rubber plug 2, facilitating the assembly and manufacturing of the hand grip rod extension fixator 1.

In one or more embodiments, the plurality of the notches 211 formed in the elastic rubber plug 2 are uniformly distributed around a central axis of the elastic rubber plug 2.

The plurality of elastic rubber plugs 2 uniformly distributed can ensure the stress balance of the elastic rubber plugs 2, thereby better reducing wobbling in the splicing pipe 4 connected with the hand grip rod extension fixator 1.

In one or more embodiments, the elastic clamping head 31 includes an elastic member 311 and a pin 312 which are in contact with each other. The pin 312 is slidably disposed in a radial direction of the main body 11, a peripheral wall of the main body 11 is provided with a hole site 111 through which one end of the pin 312 protrudes, and the elastic member 311 is disposed within the main body 11 and in contact with both the main body 11 and the pin 312.

The elastic clamping head 31 is of a simple structure and works stably. The hand grip rod extension fixator 1 and the splicing pipe 4 are convenient to disassemble and assemble.

In one or more embodiments, the elastic member 311 is an elastic sheet, spring, or elastic washer.

The availability of various types of the elastic member 311 enriches the design flexibility of the hand grip rod extension fixator 1.

In one or more embodiments, an end portion of the splicing pipe 4 is provided with an elastic rubber sleeve 5. The elastic rubber sleeve 5 is provided with an abutting ring portion 51, the abutting ring portion 51 has a smaller inner diameter than the splicing pipe 4, and an inner peripheral wall of the abutting ring portion 51 abuts against an outer wall of the main body 11.

The elastic rubber sleeve 5 can press against the outer wall of the main body 11, thereby further improving the structural stability of the splicing hand grip rod 10 and reducing wobbling at a joint of the splicing hand grip rod 10.

In one or more embodiments, the elastic rubber sleeves 5 on two adjacent splicing pipes 4 are in contact with each other, or a gap exists between the elastic rubber sleeves 5 on two adjacent splicing pipes 4.

The elastic rubber sleeves 5 on two adjacent splicing pipes 4 being in contact with each other can improve the structural stability of the splicing hand grip rod 10 to a great extent and further reduce wobbling at the joint of the splicing hand grip rod 10. The gap existing between the elastic rubber sleeves 5 on two adjacent splicing pipes 4 can reduce the requirements for processing accuracy, thereby saving the manufacturing cost.

In one or more embodiments, the elastic rubber sleeve 5 is a rotary body with an L-shaped cross section.

The elastic rubber sleeve 5 is of a simple structure and is convenient to process and form.

In one or more embodiments, the leveling frame 6 includes at least two frame bodies 61, with two adjacent frame bodies 61 being detachably connected.

The leveling frame 6 is formed by assembling a plurality of frame bodies 61 detachably connected, which helps reduce the space occupied by the leveling frame 6 during storage and transportation, thereby reducing the storage and transportation costs of the leveler.

In one or more embodiments, the frame body 61 has an accommodating cavity 62 for accommodating the splicing pipe 4 and the hand grip rod extension fixator 1.

The splicing pipe 4 and the hand grip rod extension fixator 1 can be accommodated within the frame body 61, minimizing the space occupied by the leveler during storage and transportation, and further reducing the storage and transportation costs of the leveler.

In one or more embodiments, the frame body 61 includes a first frame 611, a second frame 612, a third frame 613, and a fourth frame 614 which are sequentially connected end to end. The first frame 611 is disposed opposite to the third frame 613, and the second frame 612 is disposed opposite to the fourth frame 614.

The frame body 61 in a shape of a rectangular frame is of a simple structure and is convenient to process and manufacture.

In one or more embodiments, the frame body 61 further includes a reinforcement rod 615. One end of the reinforcement rod 615 is connected to the first frame 611, and the other end of the reinforcement rod 615 is connected to the third frame 613. Part of the first frame 611, part of the third frame 613, the second frame 612, and the reinforcement rod 615 define the accommodating cavity 62, and/or part of the first frame 611, part of the third frame 613, the fourth frame 614, and the reinforcement rod 615 define the accommodating cavity 62.

Providing the reinforcement rod 615 can improve the structural stability of the frame body 61 and reduce the risk of damage to the frame body 61, thereby prolonging the service life of the frame body 61. The accommodating cavity 62 is simply formed, which aids in controlling the manufacturing cost of the leveler.

In one or more embodiments, a plurality of reinforcement rods 615 are provided, and the accommodating cavity 62 is formed between two adjacent reinforcement rods 615.

Providing the plurality of reinforcement rods 615 further improves the structural stability of the frame body 61 to a great extent.

In one or more embodiments, the frame body 61 further includes a bottom frame 616 in a shape of a rectangular frame. The bottom frame 616 is respectively connected to the first frame 611, the second frame 612, the third frame 613, and the fourth frame 614.

The presence of the bottom frame 616 can not only improve the leveling effect of the leveler on materials, but also improve the structural stability of the frame body 61.

In one or more embodiments, a grip handle 8 is detachably installed at one end of the splicing hand grip rod 10, and can be accommodated in the accommodating cavity 62.

The grip handle 8 is detachable, which facilitates the storage and transportation of the leveler.

In one or more embodiments, two adjacent frame bodies 61 are connected through a plurality of fasteners 63.

The fastener 63 includes, but is not limited to, a bolt, a screw, a buckle, or the like. The specific type of the fastener 63 can be selected as needed, which enriches the design flexibility of the leveling frame 6.

In one or more embodiments, three or more frame bodies 61 are provided, and two adjacent frame bodies 61 are connected through three fasteners 63 arranged in a triangular configuration.

The three fasteners 63 arranged in the triangular configuration provide more excellent stability, and enhance the connection strength between two adjacent frame bodies 61, thereby improving the structural stability of the leveling frame 6.

In one or more embodiments, the leveling frame 6 is detachably connected to the splicing hand grip rod 10.

The leveling frame 6 can be completely separated from the splicing hand grip rod 10 for storage and transportation, which helps further reduce the storage and transportation costs of the splicing leveler.

In one or more embodiments, a connector 9 is detachably installed at the other end of the splicing hand grip rod 10 and includes a connecting pipe 94, and a first plate 91, a second plate 92, and a third plate 93 which are sequentially connected, the first plate 91 and the third plate 93 are located at the same side of the second plate 92, the connecting pipe 94 is connected to the second plate 92, the first plate 91 and the third plate 93 are detachably connected to the frame body 61, and the connecting pipe 94 is detachably connected to the splicing hand grip rod 10.

The connector 9 and the leveling frame 6 can be fixed at multiple points, and the splicing hand grip rod 10 is indirectly connected to the leveling frame 6 through the connector 9, which helps improve the stability of the connection between the splicing hand grip rod 10 and the leveling frame 6.

FIG. 1 to FIG. 10 show a splicing leveler according to some embodiments. The splicing leveler includes a splicing hand grip rod 10. The splicing hand grip rod 10 is connected with a leveling frame 6, a handheld ring 7 is detachably installed on the splicing hand grip rod 10, the splicing hand grip rod 10 includes at least two splicing pipes 4 and a plurality of hand grip rod extension fixators 1, and two adjacent splicing pipes 4 are detachably connected through the hand grip rod extension fixators 1.

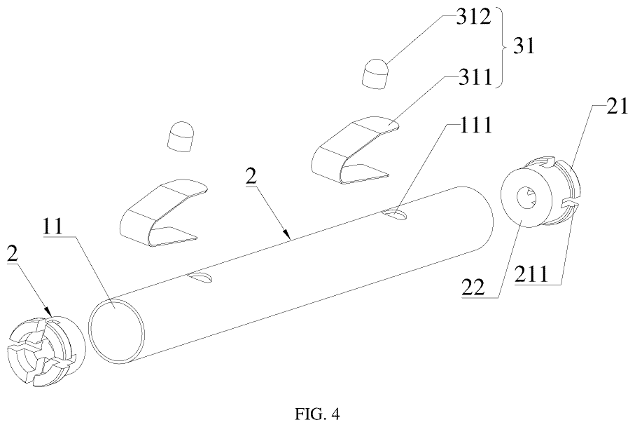

As shown in FIG. 3 and FIG. 4, the hand grip rod extension fixator 1 includes a cylindrical main body 11. To reduce the weight of the hand grip rod extension fixator 1, in some embodiments, the main body 11 is a hollow tube.

Elastic rubber plugs 2 are respectively arranged at two ends of the main body 11. The elastic rubber plug, 2 is provided with an exposed section 21 exposed out of the main body 11, and the exposed section 21 has a greater diameter than the main body 11. The main body 11 is also provided with two locking assemblies 3 respectively disposed close to the two ends of the main body 11. Each locking assembly 3 includes at least one elastic clamping head 31. An end portion of the main body 11 is inserted into the splicing pipe 4, a clamping hole 4 is formed in the splicing pipe 4 and matched with the elastic clamping head 31, and a peripheral wall of the exposed section 21 abuts against an inner wall of the splicing pipe 4, thereby ensuring a tight fit between the hand grip rod extension fixator 1 and the splicing pipes 4.

The elastic rubber plug 2 further includes an insertion section 22 connected with the exposed section 21. The insertion section 22 and the exposed section 21 are of an integrated structure integrally processed and formed. The insertion section 22 is inserted into the main body 11 to be in interference fit with the main body 11. The exposed section 21 is provided with a plurality of notches 211, the notches 211 extend from one end, away from the insertion section 22, of the exposed section 21 to the insertion section 22. In one or more embodiments, the plurality of the notches 211 formed in the elastic rubber plug 2 are uniformly distributed around a central axis of the elastic rubber plug 2. In some embodiments, four notches 211 in the clastic rubber plug 2 are formed.

As shown in FIG. 3 to FIG. 5, the elastic clamping head 31 includes an elastic member 311 and a pin 312 which are in contact with each other. The pin 312 is slidably disposed in a radial direction of the main body 11, a peripheral wall of the main body 11 is provided with a hole site 111 through which one end of the pin 312 protrudes, the elastic member 311 is disposed within the main body 11 and in contact with the main body 11 and the pin 312. The elastic member 311 is an elastic sheet, spring, elastic washer, or other structural pieces with elastic reset functions. In some embodiments, the elastic clamping head 31 is an elastic plunger finished product.

In some embodiments, the elastic member 311 is fixed together with the pin 312. This can prevent the pin 312 from falling off accidentally, and helps ensure the structural stability of the clastic clamping head 31. In some embodiments, the elastic member 311 is an elastic sheet, and at this time, the pin 312 and the elastic member 311 are of an integrated structure integrally processed and formed. In another some embodiments, the pin 312 and the elastic member 311 are connected by adhesive bonding, welding, or clipping.

In conjunction with FIG. 1 to FIG. 6, in one or more embodiments, the end portion of the splicing pipe 4 is provided with an elastic rubber sleeve 5. The elastic rubber sleeve 5 is provided with an abutting ring portion 51, the abutting ring portion 51 has s smaller inner diameter than the splicing pipe 4, and an inner peripheral wall of the abutting ring portion 51 abuts against an outer wall of the main body 11. In some embodiments, the clastic rubber sleeve 5 is a rotary body with an L-shaped cross section.

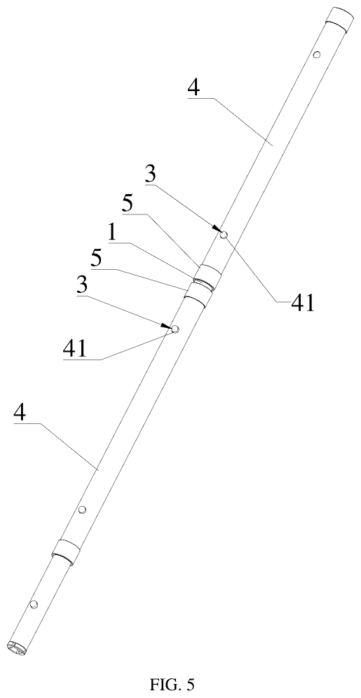

In some embodiments, the elastic rubber sleeves 5 on two adjacent splicing pipes 4 are in contact with each other, while in other embodiments, a gap exists between the elastic rubber sleeves 5 on two adjacent splicing pipes 4, as shown in FIG. 5.

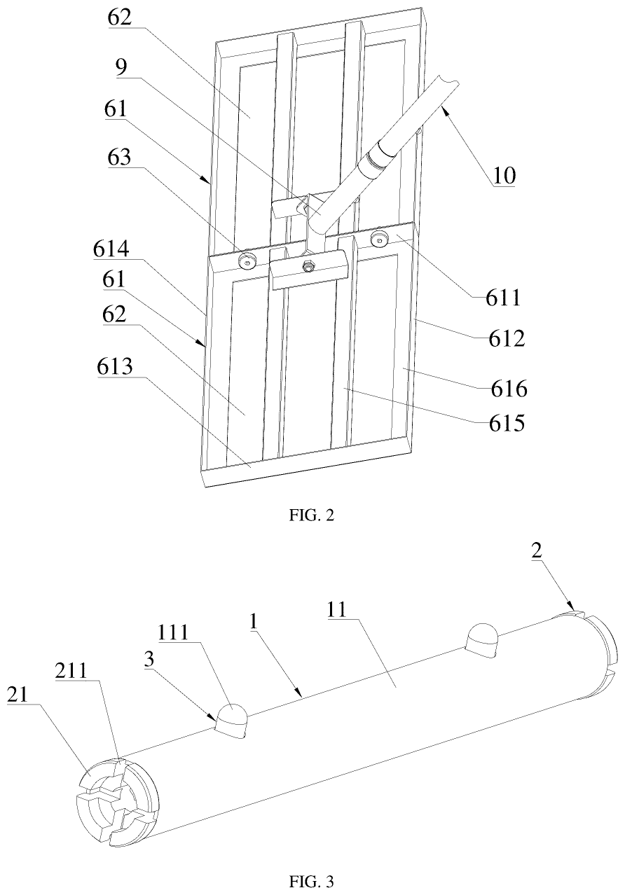

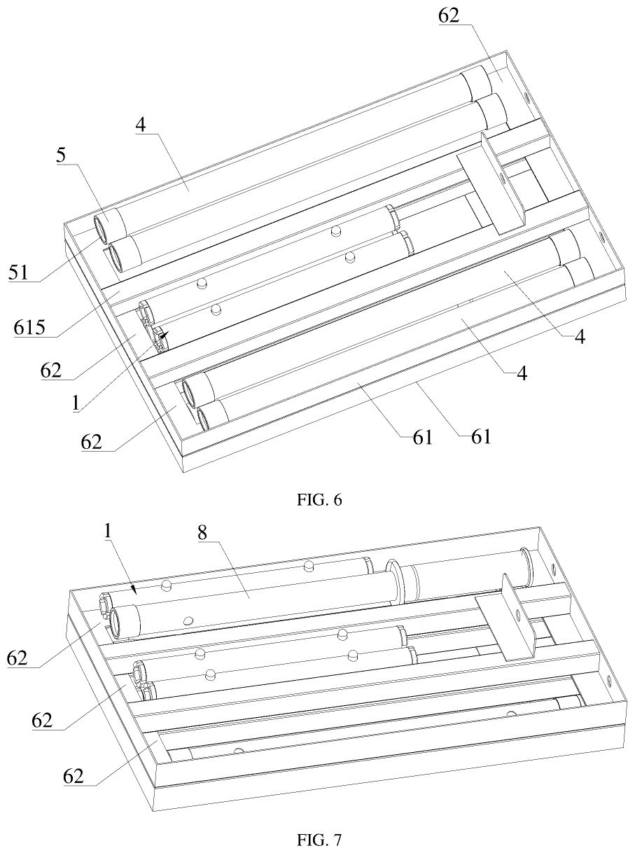

In conjunction with FIG. 1, FIG. 2, FIG. 6 and FIG. 7, to facilitate the storage and transportation of the splicing leveler to a great extent, the leveling frame 6 includes at least two frame bodies 61, and two adjacent frame bodies 61 are detachably connected through a plurality of fasteners 63. The frame body 61 has an accommodating cavity 62 for accommodating the splicing pipe 4 and the hand grip rod extension fixator 1.

The frame body 61 includes a first frame 611, a second frame 612, a third frame 613, and a fourth frame 614 which are sequentially connected end to end. The first frame 611 is disposed opposite to the third frame 613, and the second frame 612 is disposed opposite to the fourth frame 614. In one or more embodiments, the frame body 61 further includes a reinforcement rod 615. One end of the reinforcement rod 615 is connected to the first frame 611, and the other end of the reinforcement rod 615 is connected to the third frame 613. Part of the first frame 611, part of the third frame 613, the second frame 612, and the reinforcement rod 615 define the accommodating cavity 62, and/or part of the first frame 611, part of the third frame 613, the fourth frame 614, and the reinforcement rod 615 define the accommodating cavity 62.

The reinforcement rod 615 not only plays a role in enhancing the structural stability of the frame body 61, but also functions as strengthening the leveling effect of the leveling frame 6.

In some embodiments, a plurality of the reinforcement rods 615 are provided, and the accommodating cavity 62 is formed between two adjacent reinforcement rods 615, enabling full use of the internal space of the frame body 61.

The frame body 61 further includes a bottom frame 616 in a shape of a rectangular frame. The bottom frame 616 is respectively connected to the first frame 611, the second frame 612, the third frame 613, and the fourth frame 614. A height difference between a bottom surface of the reinforcement rod 615 and a bottom surface of the bottom frame 616 is less than or equal to 1 cm.

In conjunction with FIG. 1, FIG. 2 and FIG. 6, in one or more embodiments, a grip handle 8 is detachably installed at one end of the splicing hand grip rod 10, and can be accommodated in the accommodating cavity 62.

In some embodiments, one end portion of the splicing hand grip rod 10 is provided with a hand grip rod extension fixator 1. An end portion of the splicing hand grip rod 1 located at one end portion of the splicing hand grip rod 10 is inserted into the grip handle 8. A clamping hole is formed in the grip handle 8 and matched with the elastic clamping head 31 on the hand grip rod extension fixator 1. A peripheral wall of the exposed section 21 on the hand grip rod extension fixator 1 abuts against an inner wall of the grip handle 8, thereby causing a tight fit between the hand grip rod extension fixator 1 and the grip handle 8.

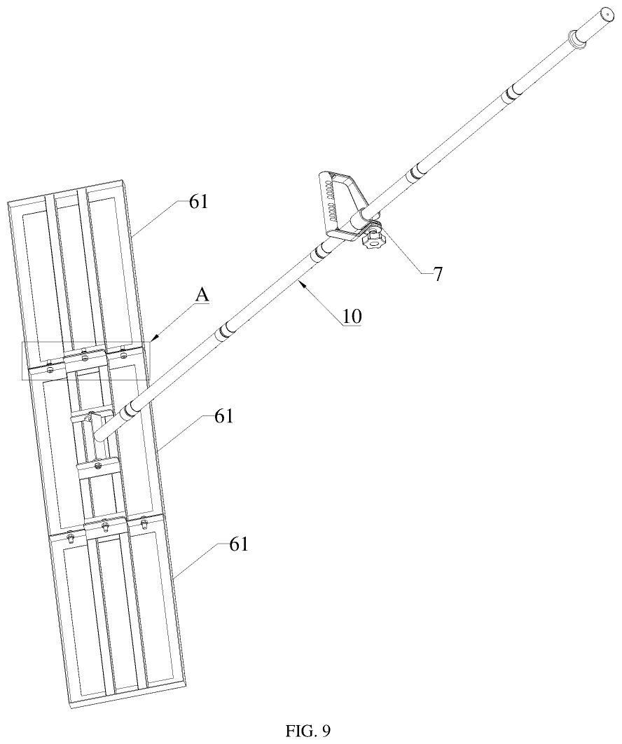

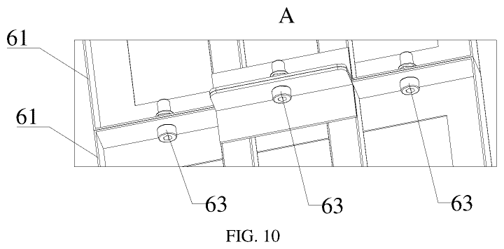

As shown in FIG. 9 and FIG. 10, in other embodiments, three or more frame bodies 61 are provided, and two adjacent frame bodies 61 are connected through three fasteners 63 arranged in a triangular configuration. In other words, a three-point fixation is formed between two adjacent frame bodies 61. The fastener 63 may be bolts or similar components.

In conjunction with FIG. 1, FIG. 2, FIG. 6, FIG. 7, FIG. 9 and FIG. 10, in one or more embodiments, the leveling frame 6 is detachably connected to the splicing hand grip rod 10.

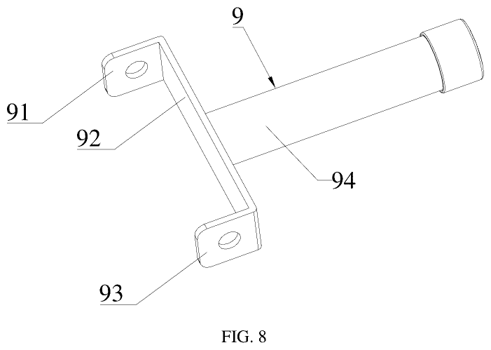

In conjunction with FIG. 1, FIG. 2 and FIG. 8, in some embodiments, a connector 9 is detachably installed at the other end of the splicing hand grip rod 10 and includes a connecting pipe 94, and a first plate 91, a second plate 92, and a third plate 93 which are sequentially connected. The first plate 91 and the third plate 93 are located at the same side of the second plate 92, the connecting pipe 94 is connected to the second plate 92, the connecting pipe 94 and the first plate 91 are located at different sides of the second plate 92, the first plate 91 and the third plate 93 are detachably connected to the frame body 61, and the connecting pipe 94 is detachably connected to the splicing hand grip rod 10.

In some embodiments, the other end portion of the splicing hand grip rod 10 is provided with a hand grip rod extension fixator 1. An end portion of the splicing hand grip rod 1 located at the other end portion of the splicing hand grip rod 10 is inserted into the connecting pipe 94. A clamping hole 41 is formed in the connecting pipe 94 and matched with the elastic clamping head 31 on the hand grip rod extension fixator 1, and a peripheral wall of the exposed section 21 on the hand grip rod extension fixator 1 abuts against an inner wall of the connecting pipe 94, thereby ensuring a tight fit between the hand grip rod extension fixator 1 and the connecting pipe 94.

When two frame bodies 61 are provided, or when four frame bodies 61 are provided and arranged in a 2×2 array, the connector 9 is detachably connected to each frame body 61, as shown in FIG. 1 and FIG. 2. When three frame bodies 61 are provided and arranged in a row, or when six frame bodies 61 are provided and arranged in a 2×3 array, the connector 9 is detachably connected to the frame body 61 located at the center of each row of frame bodies 61. In this case, the three-point fixation between two adjacent frame bodies 61 provides better stability, as shown in FIG. 9 and FIG. 10.

The above are merely embodiments of the present disclosure, and do not limit the protection scope of the present disclosure. Any equivalent transformations made to the contents of the specification and accompanying drawings of the present disclosure, or any direct or indirect applications in the related technical fields are all similarly included within the protection scope of the present disclosure.

What is claimed is:

1. A splicing leveler, comprising a splicing hand grip rod, wherein the splicing hand grip rod is connected with a leveling frame, a handheld ring is detachably installed on the splicing hand grip rod, the splicing hand grip rod comprises at least two splicing pipes and a plurality of hand grip rod extension fixators, and two adjacent splicing pipes are detachably connected through the hand grip rod extension fixators.

2. The splicing leveler according to claim 1, wherein the hand grip rod extension fixator comprises a cylindrical main body, elastic rubber plugs are respectively arranged at two ends of the main body, each of the elastic rubber plugs is provided with an exposed section exposed out of the main body, and the exposed section has a greater diameter than the main body; two locking assemblies are further arranged on the main body and are respectively disposed close to the two ends of the main body, and each locking assembly comprises at least one elastic clamping head; and an end portion of the main body is inserted into the splicing pipe, a clamping hole is formed in the splicing pipe and matched with the elastic clamping head, and the exposed section abuts against an inner wall of the splicing pipe.

3. The splicing leveler according to claim 2, wherein the elastic rubber plug further comprises an insertion section connected with the exposed section, the insertion section is inserted into the main body to be in interference fit with the main body, and the exposed section is provided with a plurality of notches which extend from one end, away from the insertion section, of the exposed section to the insertion section.

4. The splicing leveler according to claim 3, wherein the plurality of notches formed in the elastic rubber plug are uniformly distributed around a central axis of the elastic rubber plug.

5. The splicing leveler according to claim 2, wherein the elastic clamping head comprises an elastic member and a pin which are in contact with each other, the pin is slidably disposed in a radial direction of the main body, a peripheral wall of the main body is provided with a hole site through which one end of the pin protrudes, and the elastic member is disposed within the main body and is in contact with both the main body and the pin.

6. The splicing leveler according to claim 5, wherein the elastic member is an elastic sheet, spring, or elastic washer.

7. The splicing leveler according to claim 2, wherein an end portion of the splicing pipe is provided with an elastic rubber sleeve, the elastic rubber sleeve is provided with an abutting ring portion, the abutting ring portion has a smaller inner diameter than the splicing pipe, an inner peripheral wall of the abutting ring portion abuts against an outer wall of the main body.

8. The splicing leveler according to claim 7, wherein the elastic rubber sleeves on two adjacent splicing pipes are in contact with each other, or a gap exists between the elastic rubber sleeves on two adjacent splicing pipes.

9. The splicing leveler according to claim 7, wherein the elastic rubber sleeve is a rotary body with an L-shaped cross section.

10. The splicing leveler according to claim 1, wherein the leveling frame comprises at least two frame bodies, and two adjacent frame bodies are detachably connected.

11. The splicing leveler according to claim 10, wherein the frame body has an accommodating cavity for accommodating the splicing pipe and the hand grip rod extension fixator.

12. The splicing leveler according to claim 11, wherein the frame body comprises a first frame, a second frame, a third frame, and a fourth frame which are sequentially connected end to end, the first frame is disposed opposite to the third frame, and the second frame is disposed opposite to the fourth frame.

13. The splicing leveler according to claim 12, wherein the frame body further comprises a reinforcement rod, one end of the reinforcement rod is connected to the first frame, the other end of the reinforcement rod is connected to the third frame, part of the first frame, part of the third frame, the second frame, and the reinforcement rod define the accommodating cavity, and/or part of the first frame, part of the third frame, the fourth frame, and the reinforcement rod define the accommodating cavity.

14. The splicing leveler according to claim 13, wherein a plurality of the reinforcement rods are provided, and the accommodating cavity is formed between two adjacent reinforcement rods.

15. The splicing leveler according to claim 12, wherein the frame body further comprises a bottom frame in a shape of a rectangular frame, and the bottom frame is respectively connected to the first frame, the second frame, the third frame, and the fourth frame.

16. The splicing leveler according to claim 11, wherein a grip handle is detachably installed at one end of the splicing hand grip rod and can be accommodated in the accommodating cavity.

17. The splicing leveler according to claim 10, wherein two adjacent frame bodies are connected through a plurality of fasteners.

18. The splicing leveler according to claim 17, wherein three or more frame bodies are provided, and two adjacent frame bodies are connected through three fasteners arranged in a triangular configuration.

19. The splicing leveler according to claim 10, wherein the leveling frame is detachably connected to the splicing hand grip rod.

20. The splicing leveler according to claim 19, wherein a connector is detachably installed at the other end of the splicing hand grip rod and comprises a connecting pipe, and a first plate, a second plate, and a third plate which are sequentially connected, the first plate and the third plate are located at the same side of the second plate, the connecting pipe is connected to the second plate, the first plate and the third plate are detachably connected to the frame body, and the connecting pipe is detachably connected to the splicing hand grip rod.
